(19) United States
(12) Patent Application Publication
(10) Pub. No.: US 2024/0360323 A1
(43) Pub. Date: Oct. 31, 2024

(54) CALCIUM BASED NANOPARTICLE CORROSION INHIBITOR ADDITIVES

(71) Applicant: ChampionX LLC, Sugar Land, TX (US)

(72) Inventors: Jeremy Moloney, Katy, TX (US); Duy Nguyen, Richmond, TX (US)

(21) Appl. No.: 18/645,623

(22) Filed: Apr. 25, 2024

Related U.S. Application Data
(60) Provisional application No. 63/498,595, filed on Apr. 27, 2023.

(51) Int. Cl. C09D 5/10; C09D 5/08

(52) U.S. Cl. CPC C09D 5/10; C09D 5/086

(57) ABSTRACT

The present disclosure relates generally to corrosion-inhibiting compositions and methods for improved corrosion inhibition of metal surfaces used in oil and gas operations. Corrosion-inhibiting compositions include calcium-based nanoparticles for improved corrosion inhibition.

### CROSS REFERENCE TO RELATED APPLICATIONS

This application claims priority under 35 U.S.C. § 119 to provisional patent application U.S. Ser. No. 63/498,595, filed Apr. 27, 2023. The provisional patent application is herein incorporated by reference in its entirety.

### TECHNICAL FIELD

The present disclosure relates generally to corrosion-inhibiting compositions and methods for improved corrosion inhibition of metal surfaces used in oil and gas operations. Corrosion-inhibiting compositions include calcium-based nanoparticles for improved corrosion inhibition.

### BACKGROUND

Corrosion remains a significant challenge in the oil and gas industry and are most often caused by salts and/or other dissolved solids, liquids, or gases that cause, accelerate, or promote corrosion of surfaces such as metal surfaces. Examples of corrodents include water electrolytes, such as sodium chloride, calcium chloride, oxygen, hydrogen sulfide, carbon dioxide, sulfur dioxide, and the like. Corrosion negatively impacts metal surfaces such as metal pipelines, tanks, and/or other metal equipment or devices used before, during, or after injection or production.

A majority of operators in the oil and gas extraction and processing industry employ corrosion inhibitors to reduce internal corrosion in metal surfaces which are contacted by aqueous liquids containing corrodents. Corrodents are found in injectates, produced water, connate (native water present in subterranean formations along with the hydrocarbon), and hydrocarbon liquids and solids. Corrosion inhibitors are added to the liquids which come into contact with metal surfaces where they act to prevent, retard, delay, reverse, and/or otherwise inhibit the corrosion of metal surfaces such as carbon-steel metal surfaces. Corrosion inhibitors are beneficial in that they extend the lifespan of metal surfaces, as well as permit the use of carbon steel components rather than more expensive metals, such as nickel, cobalt, and chromium alloys or other materials more expensive than carbon steel and/or which inherently entail other disadvantages in suitability for the purpose of liquid or gas containment.

Corrosion inhibitors are commonly applied in a continuous manner to dose actives into a system or operation without requiring a shut-down of the system or operation. There is an ongoing need for improved continuous corrosion inhibition compositions and methods to improve corrosion inhibition efficacy.

It is therefore an object of this disclosure to provide corrosion-inhibiting compositions and methods for corrosion inhibition of metal surfaces that improve beyond the corrosion inhibition capability of existing corrosion inhibitors, by utilizing calcium-based nanoparticles in combination with corrosion inhibitors.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide compositions and methods for inhibiting corrosion in oilfield systems, namely pipelines, containing oxygen.

According to some aspects of the present disclosure, corrosion-inhibiting compositions comprise a calcium-based nanoparticle with an average particle size from about 1 nm to about 1000 nm; at least one corrosion inhibitor selected from the group consisting of quaternary ammonium compounds, imidazolines, phosphate esters, aromatic amines, fatty acid (or salts) amine condensates, organic sulfur compound and/or organic sulfonic acid amine, and combinations thereof; and solvent.

According to additional aspects of the present disclosure, use of the corrosion-inhibiting compositions described herein inhibit corrosion on a surface in an oil—and—gas system.

According to additional aspects of the present disclosure, methods of inhibiting corrosion comprise contacting the surface with a corrosive inhibiting effective amount of the corrosion-inhibiting composition described herein; and inhibiting corrosion of the surface, wherein the surface comprises metal and is in an oil—and—gas system, and wherein the contacting is added in a continuous application.

According to additional aspects of the present disclosure, treated metal containments comprise: a metal containment comprising a metal surface; and a barrier or film substantially coating the metal surface with a corrosive inhibiting effective amount of the corrosion-inhibiting composition as described herein.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION

It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, “consisting of” and “consisting essentially of”, the embodiments or elements presented herein, whether explicitly set forth or not.

The methods and compositions of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, molecular size, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyls can include straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups)(e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Commonly used alkyl groups include, but are not limited to, methyl, ethyl, n-propyl, isopropyl, n-butyl, iso-butyl, secondary-butyl, and tertiary-butyl.

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and urcido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups. In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thictane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

The term “colloidal” used herein with reference to nanoparticles refers to nanoparticles that are homogenous noncrystalline materials that are dispersions (or sols for solid-liquid systems).

As used herein, the term “containment” or “metal containment” includes any metal surface or portion thereof that is in contact with a gas or liquid phase from an oil-field system containing corrodents. In embodiments the containment is in fluid communication with one or more devices or apparatuses, including other containments. In embodiments the containment is a pipe. In embodiments the containment is a tank. In embodiments, the metal is steel. In embodiments, the steel is carbon steel. In embodiments, the carbon steel is stainless steel.

As used herein, the term “corrodent” refers to one or more salts and/or other dissolved solids, liquids, or gases that cause, accelerate, or promote corrosion of metals. Exemplary corrodents common in oil and gas applications include, water electrolytes, such as sodium chloride, calcium chloride, oxygen, hydrogen sulfide, carbon dioxide, sulfur dioxide, and the like.

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

As used herein, the term “fluid source” means any fluid used in oil or gas well production operations that contain one or more corrodents.

The term “functionalized” used herein with reference to nanoparticles refers to nanoparticles that have been modified by attaching (by covalent or non-covalent bonds) another species (organic or inorganic) onto the surface of the nanoparticle. A synonymous term to functionalized nanoparticle is a surface-functionalized or surface-modified nanoparticle. A functionalized nanoparticle as an additional chemical group attached to its surface for the purpose of providing a desired surface modification.

The term “generally” encompasses both “about” and “substantially.”

As used herein, the term “hydrocarbon” generally refers to crude petroleum products, such as crude oil or natural gas products such as methane, unless otherwise specified or determined by context. Crude petroleum products are hydrocarbon compounds as recovered or collected from a subterranean formation, and prior to any further processing or refining thereof.

The term “inhibiting” as referred to herein includes inhibiting, preventing, retarding, mitigating, reducing, controlling and/or delaying corrosion on a surface or within a system, namely an oil-field system.

As used herein, the term “injectate” means water plus any solids or liquids dispersed therein that is injected into a subterranean formation for the purpose of inducing hydrocarbon recovery therefrom. Injectates optionally include salts, polymers, surfactants, scale inhibitors, stabilizers, metal chelating agents, corrosion inhibitors, paraffin inhibitors, and other additives as determined by the operator in a subterranean hydrocarbon recovery process.

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein, the term “produced water” means water that flows back from a subterranean reservoir and is collected during a hydrocarbon recovery process including, but not limited to hydraulic fracturing and tertiary oil recovery. Produced water includes residual hydrocarbon products entrained therein and one or more of injectate, connate (native water present in the subterranean formation along with the hydrocarbon), brackish water, and sea water. Produced water ranges in temperature from about-30° C. to about 200° C., depending on the subterranean reservoir and the terranean environment and infrastructure proximal to the subterranean reservoir.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O) R_{A} wherein R_{A} is alkyl or aryl), keto (—C(O) R_{A} wherein R_{A} is alkyl or aryl), heterocyclo, and the like. Further, an alkylene group in the chain can be replaced with an ether, an amine, an amide, a carbonyl, an ester, a cycloalkyl, or a heterocyclo functional group. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

As used herein, the term “surfactant” means a compound having at least one hydrophilic portion and at least one hydrophobic portion, wherein the compound is capable of spontaneous self-aggregation in aqueous compositions. A “cationic surfactant” means a surfactant having no anionic moieties covalently bonded to the molecule and one or more cationic moieties covalently bonded to the molecule. An “anionic surfactant” means a surfactant having no cationic moieties covalently bonded to the molecule and one or more anionic moieties covalently bonded to the molecule. A “nonionic surfactant” means a surfactant having no ionic moieties covalently bonded to the molecule. An “amphoteric surfactant” means a surfactant having one or more anionic moieties covalently bonded to the molecule and one or more cationic moieties covalently bonded to the molecule, and a net molecular charge of zero.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Corrosion-Inhibiting Compositions

According to embodiments, the corrosion-inhibiting compositions include a calcium-based nanoparticle, a corrosion inhibitor and solvent. In embodiments the corrosion-inhibiting compositions include a calcium-based nanoparticle, at least one corrosion inhibitor selected from the group consisting of quaternary ammonium compounds, imidazolines, phosphate esters, aromatic amines, fatty acid (or salts) amine condensates, organic sulfur compound and/or organic sulfonic acid amine, and combinations thereof, and a solvent. The corrosion-inhibiting compositions can further include additional functional ingredients.

In embodiments the corrosion-inhibiting compositions are described in weight percentages of the compositions. While the components may have a percent active of 100%, it is noted that the percent actives of the components is not defined, but rather, total weight percentage of the raw materials (i.e. active concentration plus inert ingredients) are disclosed. In an exemplary embodiment the calcium-based nanoparticle comprises from about 0.001 wt-% to about 10 wt-% of the composition, the corrosion inhibitor(s) comprises from about 30 wt-% to about 90 wt-% of the composition, the solvent comprises from about 30 wt-% to about 90 wt-% of the composition, and the optional additional functional ingredient(s) comprises from about 0 wt-% to about 40 wt-% of the composition. In a further exemplary embodiment the calcium-based nanoparticles comprises from about 0.01 wt-% to about 10 wt—of the composition, the corrosion inhibitor(s) comprises from about 30 wt-% to about 80 wt-% of the composition, the solvent comprises from about 20 wt-% to about 70 wt-% of the composition, and the optional additional functional ingredient(s) comprises from about 0 wt-% to about 35 wt-% of the composition. In a still further exemplary embodiment the calcium-based nanoparticle comprises from about 0.1 wt-% to about 1 wt-% of the composition, the corrosion inhibitor(s) comprises from about 40 wt-% to about 70 wt-% of the composition, the solvent comprises from about 30 wt-% to about 60 wt-% of the composition, and the optional additional functional ingredient(s) comprises from about 0 wt-% to about 30 wt-% of the composition.

The corrosion-inhibiting compositions provide hydrophilic liquid compositions for treating metal surfaces in need of corrosion inhibition. Beneficially the compositions employing the calcium-based nanoparticle are compatible with additional corrosion inhibitors and without being limited to a particular mechanism of action the calcium-based nanoparticles are able to adsorb on treated metal surfaces to fill void between the corrosion inhibitors in contact with the metal surface.

### Calcium-based Nanoparticle

The corrosion-inhibiting composition comprises a calcium-based nanoparticle (Ca-NP). Beneficially, the calcium-based nanoparticles provide improvements in continuous corrosion inhibition over other metal-based nanoparticles, including for example aluminum, chromium, cobalt, copper, gold, iron, magnesium, nickel, platinum, silver, tin, titanium, tungsten, zinc, and zirconium nanoparticles.

Nanoparticles have at least one dimension less than about 1000 nm and the calcium-based nanoparticle have at least one dimension ranging from about 1-1000 nm. In some embodiments, the nanoparticles have an average particle size ranging from about 1-1000 nm; about 1-500 nm; or about 10-500 nm. In some embodiments a nanoparticle can have one of its dimensions larger than 1000 nm while another dimension is less than about 1000 nm and therefore it is considered a nanoparticle. In some embodiments, the size of a nanoparticle refers to the diameter or approximate diameter of a nanoparticle. For a population of nanoparticles, this can also be referred to as a Z-average particle size, which can be measured according to routine protocols known to one skilled in the art. In some embodiments, the size is measured by dynamic light scattering (DLS)(Z-average). In some embodiments, the size is measured by Transmission Electron Microscopy (TEM).

The nanoparticles can assume a variety of geometries, such as spheres, hollow shells, rods, plates, ribbons, prisms, stars, and combinations thereof. All geometries of nanoparticles can be employed as described herein.

The calcium-based nanoparticle can include colloidal nanoparticles.

The calcium-based nanoparticles can comprise calcium hydroxide, calcium oxyhydroxide, or calcium oxide-based nanoparticles. Examples of calcium hydroxide, calcium oxyhydroxide, or oxide-based nanoparticles include, for example, metal-based hydroxides and oxyhydroxides and silicone-based oxides.

Metal-based hydroxides include aluminum hydroxides and oxyhydroxides, such as aluminum oxyhydroxide (AlOOH-Ca) nanoparticles.

In an embodiment, the calcium-based nanoparticle is a calcium silica dioxide (SiO₂—Ca) nanoparticle. Exemplary calcium silica dioxide (SiO₂—Ca) nanoparticles can have low to high calcium content. In an embodiment, a low calcium SiO₂—Ca nanoparticle has about 2,000 ppm calcium. In a further embodiment, a high calcium SiO₂—Ca nanoparticle has about 5,000 ppm calcium. In embodiments, the calcium-based nanoparticles can comprise from about 10 ppm calcium to about 10% calcium.

In some embodiments, the calcium-based nanoparticle is a nano silica material mixed with calcium chloride. Nanosilica can include silicates, colloidal silica, silicon dioxide nanoparticle dispersion (SDND), and the like. Beneficially, the bond between the nano silica material and the calcium is not covalent or ionic. Instead, the bonding forces are electrostatic and dispersive.

In embodiments the calcium-based nanoparticle is carbonate free, namely calcium carbonate free. In embodiments the calcium-based nanoparticle is sulfonate free, namely calcium sulfonate free. In embodiments the calcium-based nanoparticle is phosphate free, namely calcium phosphate free.

In further embodiments, the calcium-based nanoparticles do not include carbon or carbon-based materials, such as carbon nanotubes (e.g., single-walled carbon nanotubes (SWCNTs), multi-walled carbon nanotubes (MWCNTs), and combinations thereof), carbon nanodiamonds, graphite, graphene, graphene oxide, fullerenes, and combinations thereof. In further embodiments, the calcium-based nanoparticle is not functionalized.

In embodiments, the calcium-based nanoparticles are not aerogels, namely they are not derived from gel and/or have a liquid component replaced with a gas.

In embodiments, the calcium-based nanoparticles are hydrophilic and provide corrosion-inhibiting compositions that are hydrophilic liquid compositions. This is distinct from hydrophobic nanoparticles, such as those with silane functionalized groups, such as perfluorooctyltrichlorosilane, heptadecafluoro decyltrimethoxysilane, trifluoropropanetrimethoxysilane, and the like providing hydrophobic nanoparticles which would precipitate out even at low concentrations. Beneficially the hydrophilic liquid compositions comprising the calcium-based nanoparticles are stabilized in the solution at much greater concentrations, including up to at least about 10%, at least about 15%, or at least about 20%.

In some embodiments, the calcium-based nanoparticle is included in the composition at an amount of at least about 0.01 wt-% to about 10 wt-%, 0.01 wt-% to about 5 wt-%, 0.1 wt-% to about 2 wt-%, about 0.1 wt-% to about 1 wt-%, or about 0.1 wt-% to about 0.5 wt-%. In addition, without being limited according to the disclosure, all ranges recited are inclusive of the numbers defining the range and include each integer within the defined range.

### Corrosion Inhibitors

The corrosion-inhibiting composition comprises at least one corrosion inhibitor. The term “corrosion inhibitor” (CI) refers to a compound or mixture of compounds that prevents, retards, mitigates, reduces, controls and/or delays corrosion. In embodiments the corrosion-inhibiting composition comprise a combination of corrosion inhibitors selected from the group consisting of quaternary ammonium compounds, imidazolines, phosphate esters, aromatic amines, fatty acid (or salts) amine condensates, organic sulfur compound and/or organic sulfonic acid amine, and combinations thereof.

In some embodiments, the corrosion inhibitors are included in the composition at an amount of at least about 30 wt-% to about 99 wt-%, about 40 wt-% to about 99 wt-%, about 50 wt-% to about 99 wt-%, about 40 wt-% to about 80 wt-%, about 50 wt-% to about 80 wt-%, or about 40 wt-% to about 70 wt-%. In addition, without being limited according to the disclosure, all ranges recited are inclusive of the numbers defining the range and include each integer within the defined range.

### Imidazolines

Imidazolines can be, for example, imidazoline derived from a diamine, such as ethylene diamine (EDA), diethylene triamine (DETA), tricthylene tetraamine (TETA), aminoethylethanolamine (AEEA), tetraethylenepentamine (TEPA), etc. and a long chain fatty acid such as tall oil fatty acid (TOFA). These can be further reacted with various acids including acetic, acrylic, etc. The imidazoline can be an imidazoline of Formula (I) or an imidazoline derivative.

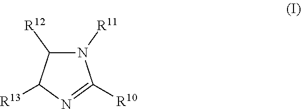

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently a C₁-C₆ alkyl group or hydrogen. An exemplary imidazolinium salt includes 1-benzyl-1-(2-hydroxyethyl)-2-tall-oil-2-imidazolinium chloride. A further exemplary imidazoline includes an R¹⁰ which is the alkyl mixture typical in tall oil fatty acid (TOFA), and R¹¹, R¹² and R¹³ are each hydrogen.

Representative imidazoline derivatives include an imidazolinium compound of Formula (II) or a bis —quaternized compound of Formula (III), each shown below:

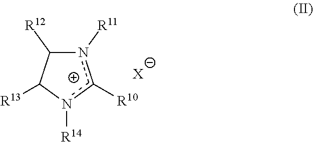

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently hydrogen or a C₁-C₆ alkyl group; and X⁻ is a halide (such as chloride, bromide, or iodide), carbonate, sulfonate, phosphate, or the anion of an organic carboxylic acid (such as acetate). Preferably, the imidazolinium compound includes 1-benzyl-1-(2-hydroxyethyl)-2-tall-oil-2-imidazolinium chloride. Exemplary corrosion inhibitors can include wherein R¹⁰ is the alkyl mixture typical in tall oil fatty acid (TOFA), and R¹¹, R¹² and R¹³ are each hydrogen.

Preferably, the imidazolinium compound includes 1-benzyl-1-(2-hydroxyethyl)-2-tall-oil-2-imidazolinium chloride, or

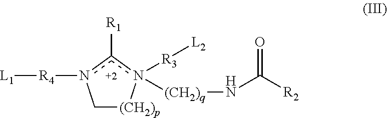

wherein: R₁, R₂, R₃ and R₄ are independently selected from the group consisting of unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; L₁ and L₂ are each independently selected from the group consisting of —H, —COOH, —SO₃H, —PO₃H₂, —COOR₄, —CONH₂, —CONHR₄, —CON(R₄)₂, and combinations thereof; and p is from 1 to about 5, and q is from 1 to about 10.

An exemplary imidazolinium compound includes 1-benzyl-1-(2-hydroxyethyl)-2-tall-oil-2-imidazolinium chloride, or the compound of formula IV:

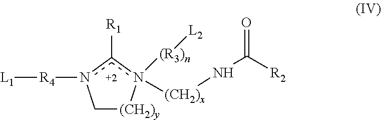

wherein: R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; R₃ and R₄ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof; L₁ and L₂ are each independently absent, H, —COOH, —SO₃H, —PO₃H₂, —COOR₅, —CONH₂, —CONHR₅, or —CON(R₅)₂; R₅ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5.

In some embodiments of formulae III and IV, preferably, R₁ and R₂ are each independently C₆-C₂₂ alkyl, C₈-C₂₀ alkyl, C₁₂-C₁₈ alkyl, C₁₆-C₁₈ alkyl, or a combination thereof; R₃ and R₄ are C₁-C₁₀ alkylene, C₂-C₈ alkylene, C₂-C₆ alkylene, or C₂-C₃ alkylene; n is 0 or 1; x (or q) is 2; y (or q) is 1; R₃ and R₄ are —C₂H₂—; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R₃ and R₄ can be C₂-C₃ alkylene such as —C₂H₂—; n is I and L₂ is —COOH or n is 0 and L₂ is absent or H; x is 2; y is 1; R₃ and R₄ are —C₂H₂—; and L₁ is —COOH.

The imidazoline corrosion inhibitor can comprise a bis-quaternized imidazoline compound having the formula (IV) wherein R₁ and R₂ are each independently C₆-C₂₂ alkyl, C₈-C₂₀ alkyl, C₁₂-C₁₈ alkyl, or C₁₆-C₁₈ alkyl or a combination thereof; R₄ is C₁-C₁₀ alkylene, C₂-C₅ alkylene, C₂-C₆ alkylene, or C₂-C₃ alkylene; x is 2; y is 1; n is 0; L₁ is —COOH, —SO₃H, or —PO₃H₂; and L₂ is absent or H. Preferably, a bis-quaternized compound has the formula (III) wherein R₁ and R₂ are each independently C₁₆-C₁₈ alkyl; R₄ is —C₂H₂—; x is 2; y is 1; n is 0; L₁ is —COOH, —SO₃H, or —PO₃H₂ and L₂ is absent or H.

Carboxylic Acid, Salt of a Fatty Acid Amine Condensate and/or Alkanolamine or Salt Thereof

The corrosion-inhibiting composition can comprise a carboxylic acid, a salt of a fatty acid amine condensate, and/or an alkanolamine or salt thereof. In some embodiments, the corrosion-inhibiting composition comprises at least two of a carboxylic acid, a salt fatty acid amine condensate, and/or an alkanolamine or salt thereof. In further embodiments, the corrosion-inhibiting composition can comprise a carboxylic acid, a salt fatty acid amine condensate, and an alkanolamine or salt thereof.

In some embodiments, the carboxylic acid, salt of a fatty acid amine condensate, and/or an alkanolamine or salt thereof is included in the composition at an amount of at least about 2 wt-% to about 40 wt-%, about 2 wt-% to about 30 wt-%, about 4 wt-% to about 30 wt-%, about 5 wt-% to about 30 wt-%, about 5 wt-% to about 25 wt-%, or about 5 wt-% to about 20 wt-%. In addition, without being limited according to the disclosure, all ranges recited are inclusive of the numbers defining the range and include each integer within the

### Salts of Fatty Acid Amine Condensates

Fatty acid amine condensates are the reaction products produced by reacting fatty acids with amines. Any amine may be used, and any fatty acid may be used. Illustrative, non-limiting examples of fatty acids are carboxylic acids with long hydrocarbon chains, the hydrocarbon chains generally having from about 10 to about 30 carbon atoms. The fatty acids may be both saturated and unsaturated.

Exemplary salts of fatty acid amine condensates can include for example, carboxylic acid-polyamine condensates, carboxylic acid alkanolamine salts, such as dicarboxylic acid diethanolamine salts, and reaction products of (1) a polyunsaturated fatty acid dimer, (2) a sulfonic acid compound, and (3) a reaction product of a polyalkylene polyamine, a tall oil fatty acid, and a polyunsaturated fatty acid dimer. A preferred salt of a fatty acid amine condensate is commercially available as tall oil acid, dimeric linoleic acid, poly C2-C4 alkylene polyamine condensate, dodecylbenzene sulfonic acid, dimeric linoleic acid salts (CAS 68910-85-0).

In embodiments where the salts of fatty acid amine condensates are carboxylic acid-polyamine condensates, examples include naphthenic acid reaction products with Diethylenetriamine and Tall Oil Fatty Acids. These also include imidazolines.

In embodiments where the salts of fatty acid amine condensates are carboxylic acid alkanolamine salts, which can include substituted aromatic amine can comprise an alkyl pyridine such as 3,5-diethyl-2-methylpyridine or 3-ethyl-4-methylpyridine, or other substituted pyridines such as (E)-5-ethyl-2-(prop-1-en-1-yl) pyridine, (E)-5-(but-2-en-1-yl)-2-methylpyridine, or N-ethyl-2-(6-methylpyridin-3-yl) ethanamine. An example employed in compositions described herein this disclosure include dicarboxylic acid diethanolamine salts, such as 2-cyclohexene-1-octanoic acid, 5 (or 6)-carboxy-4-hexyl-, compd. with 2,2′iminobis (ethanol).

In embodiments where the salts of fatty acid amine condensates are a reaction product of (1) a polyunsaturated fatty acid dimer, (2) a sulfonic acid compound, and (3) a reaction product of a polyalkylene polyamine, a tall oil fatty acid, and a polyunsaturated fatty acid dimer, the polyunsaturated fatty acid dimer (or the polyunsaturated fatty acid dimer of the reaction product (3) above) can independently comprise a dimer of linoleic acid, gamma-linolenic acid (GLA), cicosadienoic acid, dihomo-gamma-linolenic acid (DLGA), arachidonic acid (AA), docosadienoic acid, adrenic acid, docosapentaenoic acid, tetracosatetraenoic acid, tetracosapentaenoic acid, hexadecatrienoic acid (HTA), alpha-linolenic acid (ALA), stearidonic acid (SDA), eicosatrienoic acid (ETE), eicosatetraenoic acid (ETA), cicosapentaenoic acid (EPA), hencicosapentaenoic acid (HPA), docosapentaenoic acid (DPA), docosahexaenoic acid (DHA), tetracosapentaenoic acid, tetracosahexaenoic acid, mead acid, or a combination thereof. Preferably, the polyunsaturated fatty acid dimer comprises linoleic acid dimer.

The sulfonic acid compound can comprise organic sulfonic acid. Organic sulfonic acid can be an aryl sulfonic acid including, but not limited to, a linear alkylbenzenesulfonic acid, a branched alkylbenzenesulfonic acid, or other substituted or unsubstituted aromatic sulfonic acid. Suitable aryl sulfonic acids include, but are not limited to, methylbenzene sulfonic acid (e.g., p-toluenesulfonic acid), ethylbenzene sulfonic acid, butylbenzene sulfonic acid, octylbenzene sulfonic acid, dodecylbenzene sulfonic acid, and 2-naphthalene sulfonic acid. Preferably, the sulfonic acid compound comprises a linear alkyl benzene sulfonic acid such as dodecylbenzene sulfonic acid.

Organic sulfonic acid can also comprise an alkyl sulfonic acid or an arylalkyl sulfonic acid including, but not limited to methanesulfonic acid, trifluoromethanesulfonic acid, DL-camphorsulfonic acid, and phenylmethanesulfonic acid.

Organic sulfonic acid can include a monosulfonic acid, a disulfonic acid, or a polysulfonic acid. Suitable disulfonic acids include, but are not limited to, benzenedisulfonic acid, napthalenedisulfonic acid, 2,3-dimethyl-1,4-benzenedisulfonic acid, 2,4-dimethyl-1,3-benzenedisulfonic acid, 2,5-dimethyl-1,3-benzenedisulfonic acid, 2,5-dimethyl-1,4-benzenedisulfonic acid, 3,6-dimethyl-1,2-benzenedisulfonic acid, or a combination thereof. Suitable polysulfonic acids include, but are not limited to, benzene trisulfonic acid, naphthalene trisulfonic acid, 1,3,6-napthalenetrisulfonic acid, 1-nitronaphthalene-3,6,8-trisulfonic acid, or a combination thereof.

The polyalkylene polyamine of the reaction product (3) above can include, but is not limited to, a polyethylene polyamine, a polypropylene polyamine, a polybutylene polyamine, and a combination thereof. Preferably, the polyalkylene polyamine comprises a combination of polyethylene polyamine, polypropylene polyamines, and polybutylene polyamines.

Suitable polyethylene polyamines include, but are not limited to, diethylene triamine (DETA), triethylene tetramine (TETA), tetraethylene pentamine (TEPA), pentaethylene hexamine (PEHA), hexaethylene heptamine (HEHA), and higher homologues.

Suitable polypropylene polyamines include, but are not limited to, dipropylene triamine, tripropylene tetramine, tetrapropylene pentamine, pentapropylene hexamine, hexapropylene heptamine, and higher homologues.

Suitable polybutylene polyamines include, but are not limited to, dibutylene triamine, tributylene tetramine, tetrabutylene pentamine, pentabutylene hexamine, hexabutylene heptamine, and higher homologues.

Other suitable polyalkylene polyamines include bis (hexamethylene) triamine, N,N′-bis (3-aminopropyl) ethylenediamine, spermidine, and spermine.

It will be recognized by those skilled in the art that polyalkylene polyamines containing four or more nitrogen atoms are generally available as mixtures of linear, branched, and cyclic compounds, most of which contain the same number of nitrogen atoms. For example, triethylene tetramine (TETA) contains not only linear TETA, but also tris (aminoethyl) amine, N,N′-bis (2-aminoethyl) piperazine, and N-[(2-aminoethyl)-2-aminoethyl piperazine. Similarly, tetraethylene pentamine is principally a mixture of four TEPA ethyleneamines, including linear, branched, and two cyclic TEPA products.

A suitable polyalkylene polyamine is Ethyleneamine E-100, a commercially available mixture of polyethylene polyamines comprising TEPA, PEHA, and HEHA (Huntsman Corporation). Ethyleneamine E-100 typically consists of less than 1.0 wt-% of low molecular weight amine, 10-15 wt-% TEPA, 40-50 wt-% PEHA, and the balance HEHA and higher oligomers. Typically, Ethyleneamine E-100 has total nitrogen content of about 33-34 wt-% and a number average molecular weight of 250-300 g/mole.

A suitable polyamine mixture is Heavy Polyamine X (HPA-X), commercially available from Dow Chemical Company. Heavy Polyamine X is a complex mixture of linear, branched, and cyclic polyethylene polyamines, comprising TETA, TEPA, PEHA, and polyethylene polyamines (CAS No. 68131-73-7 or CAS No. 29320-38-5).

Another suitable polyamine mixture is Amix 1000 (CAS #68910 May 4), commercially available from BASF Corporation. Amix 1000 is a mixture of roughly equivalent amounts of aminoethylethanolamine, triethylene tetramine (TETA), aminoethylpiperazine, and high boiling polyamines.

The tall oil fatty acid of the reaction product (3) above can comprise any tall oil fatty acid including, but not limited to, oleic acid, linoleic acid, abictic acid, neoabictic acid, palustric acid, pimaric acid, dehydroabietic acid, palmitic acid, stearic acid, palm itoleic acid, 5,9,12-octadecatrienoic acid, linolenic acid, 5,II,14-eicosatrenoic acid, cis,cis-5,9-octadecadienoic acid, eicosadienoic acid, elaidic acid, cis-11-octadecanoic acid, or a combination thereof, as well as other C₂₀, C₂₂, C₂₄ saturated acids.

### Carboxylic Acids

Carboxylic acids include organic acids having carboxyl group attached to an R-group (R—COOH). In some embodiments, the carboxylic acid is a fatty acid, such as monomeric or oligomeric fatty acid. Exemplary monomeric or oligomeric fatty acids can include saturated and unsaturated fatty acids as well as dimer, trimer and oligomer products obtained by polymerizing one or more of such fatty acids.

### Alkanolamine or Salt Thereof

Exemplary alkanolamines or salts thereof can include for example, fatty acid alkanolamines, fatty acid ethanolamines, fatty acid diethanolamines or triethanolamines, such as dicarboxylic acid diethanolamines, and salts thereof.

### Quaternary Ammonium Compounds

The corrosion-inhibiting composition can comprise a quaternary ammonium compound. Illustrative, non-limiting examples of suitable quaternary ammonium compounds are selected from benzyldimethyldodecylammonium chloride, benzyldimethyltetradecylammonium chloride, benzyldimethylhexadecylammonium chloride, benzyldimethyloctadecyl ammonium chloride, and any combination thereof.

Quaternary ammonium compounds can have the following Formula (V):

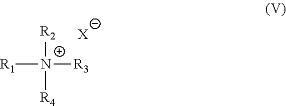

wherein R₁, R₂, and R₃ are independently C₁ to C₂₀ alkyl, R₄ is methyl or benzyl, and X⁻ is a halide or methosulfate.

Suitable alkyl, hydroxyalkyl, alkylaryl, arylalkyl or aryl amine quaternary salts include those alkylaryl, arylalkyl and aryl amine quaternary salts of the formula [N⁺R^{5a}R^{6a}R^{7a}R^{8a}][X] wherein R^{5a}, R^{6a}, R^{7a}, and R^{8a} contain one to 18 carbon atoms, and X is Cl, Br or I. For the quaternary salts, R^{5a}, R^{6a}, R^{7a}, and R^{8a} can each be independently alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X] wherein R^{5a}, R^{6a}, R^{7a}, and R^{8a} contain one to 18 carbon atoms and at least one aryl group, and X is Cl, Br or I.

Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt, wherein the alkyl group has about 6 to about 24 carbon atoms, about 10 and about 18 carbon atoms, or about 12 to about 16 carbon atoms. The quaternary ammonium salt can be a benzyl trialkyl quaternary ammonium salt, a benzyl triethanolamine quaternary ammonium salt, or a benzyl dimethylaminoethanolamine quaternary ammonium salt.

The quaternary ammonium CIs can comprise a pyridinium salt such as those represented by Formula (VI):

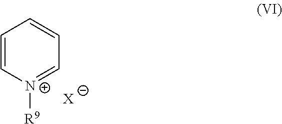

wherein R⁹ is an alkyl group, an aryl group, or an arylalkyl group, wherein said alkyl groups have from 1 to about 18 carbon atoms and X⁻is a halide such as chloride, bromide, or iodide. Among these compounds are alkyl pyridinium salts and alkyl pyridinium benzyl quats. Exemplary compounds include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium chloride and an alkyl benzyl pyridinium chloride, preferably wherein the alkyl is a C₁-C₆ hydrocarbyl group. Preferably, the pyridinium compound includes benzyl pyridinium chloride.

In some embodiments, the quaternary ammonium compound is included in the composition at an amount of at least about 10 wt-% to about 80 wt-%, about 10 wt-% to about 70 wt-%, about 10 wt-% to about 60 wt-%, about 15 wt-% to about 60 wt-%, about 20 wt-% to about 60 wt-%, or about 25 wt-% to about 60 wt-%. In addition, without being limited according to the disclosure, all ranges recited are inclusive of the numbers defining the range and include each integer within the defined range.

### Phosphate Esters

The compositions can optionally include a phosphate ester. Exemplary phosphate esters include, for example mono-, di- and tri-alkyl as well as alkylaryl phosphate esters and phosphate esters of mono, di, and triethanolamine typically contain between from 1 to about 18 carbon atoms. Preferred mono-, di- and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethylphosphate producing a broader distribution of alkyl phosphate esters.

Alternatively, the phosphate ester can be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

In some embodiments, the phosphate ester is included in the composition at an amount of at least about 1 wt-% to about 80 wt-%, about 5 wt-% to about 70 wt-%, about 10 wt-% to about 60 wt-%, about 15 wt-% to about 60 wt-%, about 20 wt-% to about 60 wt-%, or about 25 wt-% to about 60 wt-%. In addition, without being limited according to the disclosure, all ranges recited are inclusive of the numbers defining the range and include each integer within the defined range.

### Amines

The compositions can optionally include an amine, including for example aromatic amines, aliphatic amines, heterocyclic amines or alkoxylated amines, amidoamines, quaternary amines and the like.

In some embodiments, the aromatic amine is included in the composition at an amount of at least about 1 wt-% to about 80 wt-%, about 5 wt-% to about 70 wt-%, about 10 wt-% to about 60 wt-%, about 15 wt-% to about 60 wt-%, about 20 wt-% to about 60 wt-%, or about 25 wt-% to about 60 wt-%. In addition, without being limited according to the disclosure, all ranges recited are inclusive of the numbers defining the range and include each integer within the defined range.

Organic Sulfur Compound and/or Organic Sulfonic Acid Amine

The compositions can optionally include an organic sulfur compound and/or organic sulfonic acid amine. Organic sulfur compounds include for example, mercaptoalkyl alcohol, mercaptoacetic acid, thioglycolic acid, 3,3′-dithiodipropionic acid, thiosulfate, thiourea, L-cysteine, tert-butyl mercaptan, sodium thiosulfate, ammonium thiosulfate, sodium thiocyanate, ammonium thiocyanate, sodium metabisulfite, or a combination thereof. Preferably, the mercaptoalkyl alcohol comprises 2-mercaptoethanol.

Organic sulfonic acid amines include for example, alkyl or aryl sulfonic acid amines, or salts thereof, such as morpholine dodecylbenzenesulfonate.

In some embodiments, the organic sulfur compound and/or organic sulfonic acid amine is included in the composition at an amount of at least about 0.1 wt-% to about 15 wt-%, about 1 wt-% to about 10 wt-%, about 1 wt-% to about 8 wt-%, or about 2 wt-% to about 8 wt-%. In addition, without being limited according to the disclosure, all ranges recited are inclusive of the numbers defining the range and include each integer within the defined range.

### Solvent

The compositions include a solvent. In some embodiments more than one solvent is included in the compositions. An exemplary solvent is an organic solvent, including aromatic organic solvents. A further exemplary solvent is water. In embodiments combining solvents water and an additional solvent are included in the compositions.

Exemplary organic solvents can include an alcohol, a hydrocarbon, a ketone, an ether, an alkylene glycol, a glycol ether, a butyl ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, glycols and derivatives (ethylene glycol, methylene glycol, 1,2-propylene glycol, 1,3-propylene glycol, diethyleneglycol monomethyl ether, ethylene glycol monobutyl ether, ethylene glycol dibutyl ether, etc.), pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

Exemplary aromatic solvents comprise aromatic hydrocarbons such as toluene, xylene, heavy aromatic naphtha, or a combination thereof. Preferably, the aromatic solvent comprises heavy aromatic naphtha or xylene. In any of the embodiments described the aromatic solvent(s) is preferably combined with water.

Additional solvents include linear, branched, or cyclic aliphatic short chain alcohols having 1 to 6 carbon atoms, dials having 1 to 6 carbon atoms, alkyl ethers of alkylene glycols wherein the alkyl moiety has 1 to 6 carbon atoms (e.g., ethylene glycol mono-n-butyl ether), polyalkylene glycols, and mixtures thereof. In an embodiment the solvent is selected from the group consisting of methanol, ethanol, propanol, butanol, glycerol, ethylene glycol, ethylene glycol monoalkyl ether wherein the ether moiety comprises 1 to 6 carbon atoms, or a combination of two or more thereof.

In some embodiments, the composition comprises one or more solvents selected from the group consisting of xylene, isopropanol, methanol, ethanol, 2-cthylhexanol, heavy aromatic naphtha, toluene, ethylene glycol, mono butyl ether, ethylene glycol monobutyl ether (EGMBE), diethylene glycol monocthyl ether, water, or any combination thereof. In an embodiment the solvent comprises water and an additional solvent selected from the group consisting of xylene, isopropanol, methanol, ethanol, 2-ethylhexanol, heavy aromatic naphtha, toluene, ethylene glycol, mono butyl ether, ethylene glycol monobutyl ether (EGMBE), diethylene glycol monocthyl ether, or any combination thereof.

In some embodiments, the composition comprises water and an additional solvent comprising a short chain alcohol and/or ether (e.g., ethylene glycol monobutyl ether (EGMBE)) to form microemulsions with the water, nanoparticle, corrosion inhibitor, surfactant and optional additional functional ingredients.

The composition comprising water and an additional solvent enhances stability of the compositions to prevent precipitation of the calcium-based nanoparticle, corrosion inhibitor and/or additional functional ingredients that otherwise render the corrosion inhibitors and/or additional functional ingredients less effective. In embodiments the composition do not exhibit cloudiness, precipitation, separation, gelation, or any other behavior attributable to instability.

In some embodiments, the solvent(s) is included in the composition at an amount of at least about 30 wt-% to about 90 wt-%, about 30 wt-% to about 80 wt-%, or about 40 wt-% to about 80 wt-%. In addition, without being limited according to the disclosure, all ranges recited are inclusive of the numbers defining the range and include each integer within the

### Additional Functional Ingredients

The corrosion-inhibiting compositions can further be combined with various additional functional components suitable for uses disclosed herein. In some embodiments, the compositions including the calcium-based nanoparticle, corrosion inhibitor(s) and solvents make up a large amount, or even substantially all of the total weight of the compositions. For example, in some embodiments few or no additional functional ingredients are disposed therein. In some embodiments, the composition comprises, consists essentially of, or consists of the calcium-based nanoparticle, corrosion inhibitor(s) and solvents.

In other embodiments, additional functional ingredients may be included in the compositions. The functional ingredients provide desired properties and functionalities to the compositions. For the purpose of this application, the term “functional ingredient” includes a material that when dispersed or dissolved in the use and/or concentrate compositions described herein provides a beneficial property in a particular use.

In some embodiments, the compositions including the calcium-based nanoparticle, a corrosion inhibitor, solvents and at least one surfactant make up a large amount, or even substantially all of the total weight of the compositions. In some embodiments, the composition comprises, consists essentially of, or consists of the calcium-based nanoparticle, a corrosion inhibitor, solvents and at least one surfactant.

In some embodiments, the compositions may include additional corrosion inhibitors, surfactants, polymers, pH modifiers, surfactants, hydrate inhibitors, scale inhibitors, biocides, salt substitutes, relative permeability modifiers, sulfide scavengers, breakers, asphaltene inhibitors, paraffin inhibitors, metal complexing agents (chelants), emulsifiers or coupling agents, demulsifiers, iron control agents, friction reducers, drag reducing agents, flow improvers, viscosity reducers, stability component, and the like. Exemplary types of the various additional functional ingredients is included in U.S. Pat. No. 11,242,480, which is incorporated by reference in its disclosure of the various listings of additional functional ingredients.

In further embodiments, the composition may include at least one additional component selected from the group consisting of additional corrosion inhibitors, pH modifiers, asphaltene inhibitors, paraffin inhibitors, scale inhibitors, metal complexing agents (chelants), surfactants, emulsifiers or coupling agents, water clarifiers, dispersants, emulsion breakers and combinations thereof.

According to embodiments of the disclosure, the various additional functional ingredients may be provided in a composition in the amount from about 0 wt-% and about 40 wt-%, from about 0 wt-% and about 30 wt-%, from about 0 wt-% and about 20 wt-%, from about 0.01 wt-% and about 40 wt-%, from about 0.1 wt-% and about 40 wt-%, from about 0.1 wt-% and about 30 wt-%, from about 0.1 wt-% and about 20 wt-%, or from about 1 wt-% and about 2 wt-%, or from about 1 wt-% and about 10 wt-%. In addition, without being limited according to the disclosure, all ranges recited are inclusive of the numbers defining the range and include each integer within the defined range. Additional examples of additional functional ingredients are listed herein as exemplary wt-% ranges based on the total weight of the compositions, in addition these weight percentage ranges.

The compositions can optionally include a demulsifier. An exemplary demulsifier comprises an oxyalkylate polymer, such as a polyalkylene glycol. The demulsifier can be included in the compositions from about 0.5 to 5 wt-% of the composition, based on total weight of the composition.

The compositions can optionally include an asphaltene inhibitor. Suitable asphaltene inhibitors include, but are not limited to, aliphatic sulfonic acids; alkyl aryl sulfonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride. The asphaltene inhibitor can be included in the compositions from about 0.1 to 10 wt-% of the composition, based on total weight of the composition.

The compositions can optionally include a paraffin inhibitor. Suitable paraffin inhibitors include, but are not limited to, paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes. Suitable dispersants include, but are not limited to, dodecyl benzene sulfonate, oxyalkylated alkylphenols, and oxyalkylated alkylphenolic resins. The paraffin inhibitor can be included in the compositions from about 0.1 to 10 wt-% of the composition, based on total weight of the composition.

The compositions can optionally include a scale inhibitor. Suitable scale inhibitors include, but are not limited to, phosphates, phosphate esters, phosphoric acids, phosphonates, phosphonic acids, polyacrylamides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AMPS). The scale inhibitor can be included in the compositions from about 0.1 to 20 wt-% of the composition, based on total weight of the composition.

The compositions can optionally include an emulsifier. Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers). The emulsifier can be included in the compositions from about 0.1 to 10 wt-% of the composition, based on total weight of the composition.

The compositions can optionally include a water clarifier. Suitable water clarifiers include, but are not limited to, inorganic metal salts such as alum, aluminum chloride, and aluminum chlorohydrate, or organic polymers such as acrylic acid-based polymers, acrylamide based polymers, polymerized amines, alkanolamines, thiocarbamates, and cationic polymers such as diallyldimethylammonium chloride (DADMAC). The water clarifier can be included in the compositions from about 0.1 to 10 wt-% of the composition, based on total weight of the composition.

The compositions can optionally include a dispersant. Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra (methylene phosphonate), diethylenetriamine penta (methylene phosphonate), and the triamine—and tetramine-polymethylene phosphonates with 2-4 methylene groups between each N atom, at least 2 of the numbers of methylene groups in each phosphonate being different. Other suitable dispersion agents include lignin, or derivatives of lignin such as lignosulfonate and naphthalene sulfonic acid and derivatives. The dispersant can be included in the compositions from about 0.1 to 10 wt-% of the composition, based on total weight of the composition.

The compositions can optionally include an emulsion breaker. Suitable emulsion breakers include, but are not limited to, dodecylbenzylsulfonic acid (DDBSA), the sodium salt of xylenesulfonic acid (NAXSA), epoxylated and propoxylated compounds, anionic, cationic and nonionic surfactants, and resins, such as phenolic and epoxide resins. The emulsion breaker can be included in the compositions from about 0.1 to 10 wt-% of the composition, based on total weight of the composition.

The compositions can optionally include a hydrogen sulfide scavenger. Suitable additional hydrogen sulfide scavengers include, but are not limited to, oxidants (e.g., inorganic peroxides such as sodium peroxide or chlorine dioxide); aldehydes (e.g., of 1-10 carbons such as formaldehyde, glyoxal, glutaraldehyde, acrolein, or methacrolein; triazines (e.g., monocthanolamine triazine, monomethylamine triazine, and triazines from multiple amines or mixtures thereof); condensation products of secondary or tertiary amines and aldehydes, and condensation products of alkyl alcohols and aldehydes. The hydrogen sulfide scavenger can be included in the compositions from about 0.5 to 20 wt-% of the composition, based on total weight of the composition.

The compositions can optionally include a gas hydrate inhibitor. Suitable gas hydrate inhibitors include, but are not limited to, thermodynamic hydrate inhibitors (THI), kinetic hydrate inhibitors (KHI), and anti-agglomerates (AA). Suitable thermodynamic hydrate inhibitors include, but are not limited to, sodium chloride, potassium chloride, calcium chloride, magnesium chloride, sodium bromide, formate brines (e.g. potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, and sugar alcohols (e.g. sorbitol, mannitol)), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate). The gas hydrate inhibitor can be included in the compositions from about 0.1 to 25 wt-% of the composition, based on total weight of the composition.

The compositions can optionally include a kinetic hydrate inhibitor or anti-agglomerate. Suitable kinetic hydrate inhibitors and anti-agglomerates include, but are not limited to, polymers and copolymers, polysaccharides (such as hydroxyethylcellulose (HEC), carboxymethylcellulose (CMC), starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines), hydrocarbon based dispersants (such as lignosulfonates, iminodisuccinates, polyaspartates), amino acids, and proteins. The kinetic hydrate inhibitor can be included in the compositions from about 0.1 to 25 wt-% of the composition, based on total weight of the composition.

The compositions can optionally include a biocide. Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis (hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides. The biocide can be included in the compositions from about 0.1 to 10 wt-% of the composition, based on total weight of the composition.

The compositions can optionally include a pH modifier. Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include sodium hydroxide, potassium hydroxide, calcium hydroxide, calcium oxide, sodium carbonate, potassium carbonate, sodium bicarbonate, potassium bicarbonate, magnesium oxide, and magnesium hydroxide. The pH modifier can be included in the compositions from about 0.1 to 10 wt-% of the composition, based on total weight of the composition.

The compositions can optionally include a surfactant. The composition can also include one or more surfactants. The surfactant can be included in the compositions from about 0.1 to 10 wt-% of the composition, from about 0.5 to 10 wt-% of the composition, or from about 0.5 to 5 wt-% of the composition, based on total weight of the composition. In embodiments with a surfactant a water in oil microemulsion is formed where the water phase contains the nanoparticle dispersed in the oil phase.

Suitable surfactants include, but are not limited to, anionic surfactants, nonionic surfactants and/or amphoteric surfactants.

Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates. In some embodiments the sulfosuccinates include C₈-C₂₂ sulfosuccinates. In still other embodiments the anionic surfactant is sodium dodecylbenzene sulfonate, nacconol 90G, dioctyl sodium sulfosuccinate, sodium-toluene sulfonate, sodium benzene sulfonate, linear alkylbenzene sulfonates (LAS) or sodium dodecyl sulfate (SDS). In still other embodiments the anionic surfactants are salts (including, for example, sodium, potassium, ammonium, and substituted ammonium salts such as mono-, di-, and triethanolamine salts) of the anionic sulfate, sulfonate, carboxylate and sarcosinate surfactants. In embodiments the inclusion of a surfactant is preferably an oil soluble surfactant having an HLB less than or equal to about 8, or from about 3 to about 8, and provide stabilizing benefits for the composition.

In some embodiments the composition comprises at least one anionic surfactant comprising an amine salt of a sulfonate, sulfate, and/or carboxylate. In a preferred embodiment the anionic surfactant is sodium dodecylbenzene sulfonate and a substituted ammonium salts such as mono-, di-, and triethanolamine salts of the anionic sulfonate. In embodiments the ratio of the sulfonate, sulfate, and/or carboxylate surfactant to the amine salt thereof is from about 1:1 moles to about 1:10 moles.

Nonionic surfactants include alcohol alkoxylates, alkylphenol alkoxylates, block copolymers of ethylene, propylene and butylene oxides, alkyl dimethyl amine oxides, alkyl-bis (2-hydroxyethyl) amine oxides, alkyl amidopropyl dimethyl amine oxides, alkylamidopropyl-bis (2-hydroxyethyl) amine oxides, alkyl polyglucosides, polyalkoxylated glycerides, sorbitan esters and polyalkoxylated sorbitan esters, and alkoyl polyethylene glycol esters and diesters.

In some embodiments the nonionic surfactants are one or more surfactants selected from the group comprising, consisting essentially of, or consisting of alkoxylated alcohols, alkoxylated alkyl phenols, or ethylene oxide/propylene oxide copolymers. In other embodiments the nonionic surfactants are alkoxylated alcohols, alkoxylated alkyl phenols, or ethylene oxide/propylene oxide copolymers having an hydrophilic-lipophilic balance (HLB) greater than about 10, having an HLB greater than about 10, for example about 10 to 20, or about 10 to 18, or about 10 to 16, or about 10 to 14, or about 11 to 20, or about 11 to 18, or about 11 to 17, or about 11 to 16, or about 11 to 15, or about 11 to 14, or about 11 to 13, and mixtures of these compounds.

In some embodiments, the nonionic surfactants are ethoxylated C6-C14 or C10-C14 alcohols and alkyl phenols. In some embodiments the nonionic surfactants are polyoxyethylene alkyl ether, polyoxyethylene alkylphenol ether, ethylene oxide-propylene oxide block copolymers, alkyl glucoside, polyoxyethylene fatty acid ester, sucrose fatty acid ester, sorbitan fatty acid ester, polyoxyethylene sorbitan fatty acid ester, and fatty acid alkanolamide. In some embodiments the nonionic surfactant is ethoxylated castor oil, dimethyl-lauryl-amine, C10-16 alkyl dimethylamines, alkoxylated ethylenediamine, ethoxylated alcohol, ethoxylated hexanol or mixtures thereof.

The amphoteric surfactant, also termed a zwitterionic surfactant, includes at least one internal anionic moiety, at least one internal cationic moiety, and has a net internal charge of zero. In some embodiments, the amphoteric surfactant comprises, consists essentially of, or consists of a single internal cation, a single internal anion, and a hydrophobic moiety selected from linear, branched, alicyclic, aryl, and alkaryl groups having 6 to 50 carbon atoms. In some embodiments, the amphoteric surfactant includes at least one internal cationic moiety comprising ammonium or phosphonium; and at least one internal anionic moiety comprising sulfonate, sulfate, oxide, carboxylate, phosphate, phosphite, or phosphonate. In some embodiments, the amphoteric surfactant includes at least one internal cationic moiety comprising ammonium or phosphonium; and at least one internal anionic moiety comprising sulfonate. In some embodiments, the amphoteric surfactant includes at least one internal hydroxyl group.

Examples of useful amphoteric surfactants include those having a hydrophobic moiety selected from linear, branched, alicyclic, aryl, and alkaryl groups having 6 to 50 carbon atoms, or 8 to 50 carbon atoms, or 10 to 50 carbon atoms, or 12 to 50 carbon atoms, or 6 to 40 carbon atoms, or 6 to 30 carbon atoms, or 8 to 30 carbon atoms, or 10 to 30 carbon atoms, or 10 to 16 carbon atoms, or 12 to 30 carbon atoms. One useful class of amphoteric surfactants is amino acids having a hydrophobic moiety selected from linear, branched, alicyclic, aryl, and alkaryl groups having 6 to 50 carbon atoms, or 8 to 50 carbon atoms, or 10 to 50 carbon atoms, or 12 to 50 carbon atoms, or 6 to 40 carbon atoms, or 6 to 30 carbon atoms, or 8 to 30 carbon atoms, or 10 to 30 carbon atoms, or 10 to 16 carbon atoms, or 12 to 30 carbon atoms, including for example N-dodecyl-N,N-dimethyl glycine. Another class of useful amphoteric surfactants is trialkylamine oxides having a hydrophobic moiety selected from linear, branched, alicyclic, aryl, and alkaryl groups having 6 to 50 carbon atoms, or 8 to 50 carbon atoms, or 10 to 50 carbon atoms, or 12 to 50 carbon atoms, or 6 to 40 carbon atoms, or 6 to 30 carbon atoms, or 8 to 30 carbon atoms, or 10 to 30 carbon atoms, or 10 to 16 carbon atoms, or 12 to 30 carbon atoms. Representative examples of such amphoteric surfactants include N,N-dimethyl-N-dodecyl amine oxide, N,N-dimethyl-N-hexadecyl amine oxide, N,N-dimethyl-N-octadecyl amine oxide, and N,N-dimethyl-N-(Z-9-octadecenyl)—N-amine oxide.

Another class of useful amphoteric surfactants is betaines, which include one internal carboxylate moiety, one internal ammonium moiety, and a hydrophobic moiety selected from linear, branched, alicyclic, alkyl, aryl, and alkaryl groups having 6 to 50 carbon atoms, or 8 to 50 carbon atoms, or 10 to 50 carbon atoms, or 12 to 50 carbon atoms, or 6 to 40 carbon atoms, or 6 to 30 carbon atoms, or 8 to 30 carbon atoms, or 10 to 30 carbon atoms, or 10 to 16 carbon atoms, or 12 to 30 carbon atoms. Representative but nonlimiting examples of betaines include 2-(dodecyldimethylammonio) acetate (CAS No. 683-10-3), cocamidopropyl betaine (2-[3-(dodecanoylamino) propyl-dimethylazaniumyl]acetate), dodecanamidopropyl betaine ({2-[3-(dodecanoylamino) propyl]triazan-2-ium-2-yl}acetate), cetyl betaine (2-[hexadecyl (dimethyl) azaniumyl]acetate), oleamidopropyl betaine ((Z)-(carboxymethyl) dimethyl-3-((1-oxo-9-octadecenyl) amino) propylammonium hydroxide), caprylamidopropyl betaine (2-[dimethyl-[3-(octanoylamino) propyl]azaniumyl]acetate), and C10-16-alkyl (2-hydroxy-3-sulfopropyl) dimethyl (Mackam™ LHS supplied by Solvay.)

Another class of useful amphoteric surfactants is sultaines, which include one internal sulfonate moiety and one internal ammonium moiety (also referred to as sulfobetaines). Examples of sultaines are lauryl sulfobetaine (3-(dodecyldimethylammonio) propane-1-sulfonate), caprylyl sulfobetaine (3-[decyl (dimethyl) azaniumyl]propane-1-sulfonate), myristyl sulfobetaine (3-[dimethyl (tetradecyl) azaniumyl]propane-1-sulfonate), Sulfobetaine 10 (CAS No. 15163-36-7), Sulfobetaine 3-14 (N-tetradecyl-N,N-dimethyl-3-ammonio-1-propanesulfonate), Sulfobetaine 3-10 (N-decyl-N,N-dimethyl-3-ammonio-1-propanesulfonate); alkylether hydroxypropyl sultaines and alkyldimethylhydroxysultaines such as lauryl hydroxysultaine (3-[dodecyl (dimethyl) ammonio]-2-hydroxypropane-1-sulfonate; 351.55 g/mol; CAS No. 13197-76-7), myristamidopropyl hydroxysultaine (2-hydroxy-N,N-dimethyl-N-(3-((1-oxotetradecyl) amino) propyl)-3-sulfo-, inner salt); cocoamidopropyl hydroxysultaine, and the like. Mixtures of such surfactants having various carbon chain lengths are obtained in some embodiments; for example, 3-((C₁₀-C₁₆)-alkyldimethylammonio)-2-hydroxypropanesulfonate (CAS No. 72869-77-3) is a mixture of alkylated moieties having an average of 10 to 16 carbons.

Another class of useful amphoteric surfactants is phosphate functional amphoteric surfactants, which include one internal phosphate moiety, one internal ammonium moiety, optionally a carboxylate moiety, and either one or two hydrophobic moieties, wherein each hydrophobic moiety is selected from linear, branched, alicyclic, aryl, and alkaryl groups having 6 to 50 carbon atoms, or 8 to 50 carbon atoms, or 10 to 50 carbon atoms, or 12 to 50 carbon atoms, or 6 to 40 carbon atoms, or 6 to 30 carbon atoms, or 8 to 30 carbon atoms, or 10 to 30 carbon atoms, or 12 to 30 carbon atoms. Representative but nonlimiting examples of phosphate functional amphoteric surfactants include phosphatidylserines, phosphatidylethanolamines, phosphatidylcholines such as 1-oleoyl-2-palmitoyl-phosphatidylcholine, and sphingomyelins.

In some embodiments, the weight ratio of the amphoteric surfactant to the nonionic surfactant in the compositions is about 10:1 to 1:10, or about 9:1 to 1:10, or about 8:1 to 1:10, or about 7:1 to 1:10, or about 6:1 to 1:10, or about 5:1 to 1:10, or about 4:1 to 1:10, or about 3:1 to 1:10, or about 2:1 to 1:10, or about 1:1 to 1:10, or about 10:1 to 1:5, or about 9:1 to 1:5, or about 8:1 to 1:5, or about 7:1 to 1:5, or about 6:1 to 1:5, or about 5:1 to 1:5, or about 4:1 to 1:5, or about 3:1 to 1:5, or about 2:1 to 1:5, or about 1:1 to 1:5, or about 10:1 to 1:3, or about 9:1 to 1:3, or about 8:1 to 1:3, or about 7:1 to 1:3, or about 6:1 to 1:3, or about 5:1 to 1:3, or about 4:1 to 1:3, or about 3:1 to 1:3, or about 2:1 to 1:3, or about 1:1 to 1:3, or about 10:1 to 1:2, or about 9:1 to 1:2, or about 8:1 to 1:2, or about 7:1 to 1:2, or about 6:1 to 1:2, or about 5:1 to 1:2, or about 4:1 to 1:2, or about 3:1 to 1:2, or about 2:1 to 1:2, or about 1:1 to 1:2, or about 10:1 to 1:1, or about 9:1 to 1:1, or about 8:1 to 1:1, or about 7:1 to 1:1, or about 6:1 to 1:1, or about 5:1 to 1:1, or about 4:1 to 1:1, or about 3:1 to 1:1, or about 2:1 to 1:1.

In other embodiments, the molar ratio of the amphoteric surfactant to the nonionic surfactant in the compositions is about 10:1 to 1:3, or about 9:1 to 1:3, or about 8:1 to 1:3, or about 7:1 to 1:3, or about 6:1 to 1:3, or about 5:1 to 1:3, or about 4:1 to 1:3, or about 3:1 to 1:3, or about 2:1 to 1:3, or about 1:1 to 1:3, or about 10:1 to 1:2, or about 9:1 to 1:2, or about 8:1 to 1:2, or about 7:1 to 1:2, or about 6:1 to 1:2, or about 5:1 to 1:2, or about 4:1 to 1:2, or about 3:1 to 1:2, or about 2:1 to 1:2, or about 1:1 to 1:2, or about 10:1 to 1:1, or about 9:1 to 1:1, or about 8:1 to 1:1, or about 7:1 to 1:1, or about 6:1 to 1:1, or about 5:1 to 1:1, or about 4:1 to 1:1, or about 3:1 to 1:1, or about 2:1 to 1:1.

In some embodiments the surfactants are a blend of amphoteric surfactants, anionic surfactants, nonionic surfactants and mixtures thereof. In some embodiments, the anionic surfactants are salts (including, for example, sodium, potassium, ammonium, and substituted ammonium salts such as mono-, di-, and triethanolamine salts) of the anionic sulfate, sulfonate, carboxylate and sarcosinate surfactants. In other embodiments, the anionic surfactants are isethionates such as the acyl isethionates, N-acyl taurates, fatty acid amides of methyl tauride, alkyl succinates, sulfoacetates, and sulfosuccinates, monoesters of sulfosuccinate (e.g., saturated and unsaturated C12-C18 monoesters), diesters of sulfosuccinate (e.g., saturated and unsaturated C6-C14 diesters), and N-acyl sarcosinates.

In some embodiments the anionic surfactant is a sulfosuccinate. In some embodiments the sulfosuccinate are C8-C22 sulfosuccinates. In still other embodiments the anionic surfactant is sodium dodecylbenzene sulfonate, nacconol 90G, dioctyl sodium sulfosuccinate, sodium-toluene sulfonate, sodium benzene sulfonate, linear alkylbenzene sulfonates (LAS) or sodium dodecyl sulfate (SDS).

In some embodiments, the weight ratio of the amphoteric surfactant to the nonionic surfactant to the anionic surfactant in the surfactant compositions is about 100:1:1; 1:100:1; 1:1:100; 10:1:1; 1:10:1; 1:1:10; or 1:1:1.

The compositions can optionally include a stability component. In some embodiments the stability component is a sulfate, chloride, carbonate, or oxide salt of aluminum, titanium or zirconium. In some embodiments the stability component is from 0.1-10 wt % of the composition. In some embodiments, the stability component is aluminum sulfate and in other embodiments the aluminum sulfate is from 0.1-10 wt % of the composition.

### Methods of Use

The corrosion-inhibiting compositions are provided to a system in need of effective corrosion control in the presence of corrodents. Without being limited to a particular mechanism of action the corrosion-inhibiting compositions providing the calcium-based nanoparticle in combination with corrosion inhibitors enhances the corrosion inhibition through the nanoparticle's adsorption on the metal surface by electrostatic and/or dispersive forces and filing voids on the metal surface between the corrosion inhibitors in contact therewith.

The corrosion-inhibiting compositions can be provided in a single composition to a liquid system. In referring to compositions, the scope of the methods of using disclosure also includes combining more than one input (i.e. composition) for the treatment of the liquid system in need of corrosion inhibition.

The methods apply the compositions to a fluid to prevent, reduce or mitigate corrosion. The mils penetration per year or milli-inch (one thousandth of an inch)(MPY) is used as an estimated general corrosion rate. The MPY is calculated from the following equation:

$$M P Y = ( Δ M [ g ] \cdot C ) / ( ρ [ \frac{g}{{cm}^{2}} ] \cdot A [ {in}^{2} ] \cdot t [ hr ] )$$

where ΔM is the mass loss of the coupon at the end of the test in grams, C is a constant equal to 534000, p is the density of the coupon in g/cm², A is the surface area of the coupon in cm², and t is the exposure time in hours. In an embodiment, the corrosion inhibiting compositions provide a reduction in corrosion measured by a milli-inches per year less than about 50.

In embodiments, the corrosion-inhibiting composition provides about a 30% to about a 70% inhibited corrosion rate compared to the same corrosion-inhibiting composition without the calcium-based nanoparticle.

In embodiments, the corrosion-inhibiting composition provides about a 90% or greater, or 95% or greater percentage protection as measured based on mpy of the treated metal surfaces.

The methods may be applied to fluid systems moving through conduits, pipes, transfer lines, valves, and other places or equipment where hydrocarbon fluids are subject to corrosion. The compositions can be applied to a fluid system at various pH ranges, such as between about 2 to about 10, and temperatures, such as from about 25° C. to about 250° C., as well as various levels of water cut and/or various levels of salinity. The compositions can also be applied to a fluid system at various water cuts and salinity.

In embodiments, the fluid system comprises a hydrocarbon fluid, produced water, or combination thereof. As referred to herein, hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof. In many embodiments, hydrocarbon fluids comprise refined hydrocarbon product.

In embodiments the fluid system is contained in an oil or gas pipeline or refinery. A fluid to which the compositions can be introduced can be a liquid hydrocarbon. The liquid hydrocarbon can be any type of liquid hydrocarbon. The fluid can be a refined hydrocarbon product.

The fluid can be contained in and/or exposed to many different types of apparatuses. In embodiments, the fluid is contained in a containment, such as an oil and gas pipeline. Additionally, the fluid can be contained in refineries, such as surfaces used in the recovery, transportation, refining and/or storage of hydrocarbon fluids or gases. Exemplary surfaces can include separation vessels, dehydration units, gas lines, oil and/or gas pipelines, or other part of an oil and/or gas refinery. Similarly, the fluid can be contained in and/or exposed to an apparatus used in oil extraction and/or production, such as a wellhead. The apparatus can be part of a coal-fired power plant. The apparatus can be a cargo vessel, a storage vessel, a holding tank, or a pipeline connecting the tanks, vessels, or processing units.

The system to be treated has at least one surface susceptible to corrosion, namely the surface comprises a metal surface subject to corrosion. In embodiments the surfaces can include a variety of metal surfaces that are subject to corrosion. The metals can comprise a component selected from the group consisting of mild steel, galvanized steel, carbon steel, aluminum, aluminum alloys, copper, copper nickel alloys, copper zinc alloys, brass, chrome steels, ferritic alloy steels, austenitic stainless steels, precipitation-hardened stainless steels, high nickel content steels, and any combination thereof.

The compositions can be applied by any appropriate method for ensuring dispersal through the fluid, including for example injecting, pumping, pouring, spraying, dripping, or otherwise adding. The compositions can be applied to a fluid using various well-known methods and they can be applied at numerous different locations throughout a given system. For example, the compositions can be injected using mechanical equipment such as chemical injection pumps, piping tees, injection fittings, atomizers, quills, and the like. The compositions can be pumped into an oil and/or gas pipeline using an umbilical line, including capillary string injection systems. U.S. Pat. No. 7,311,144 provides a description of an apparatus and methods relating to capillary injection, the disclosure of which is incorporated into the present application in its entirety.

The method comprises adding a corrosion inhibiting effective amount of the composition to the fluid system in a batch or continuous dosing. The dosage amounts of the compositions described herein to be added to the fluid system can be tailored by one skilled in the art based on factors for each fluid system in need of treatment, including, for example, content of fluid, volume of the fluid, surface area of the system, CO₂ content, temperatures, pH, and CO₂ content. In embodiments, an effective amount of the corrosion-inhibiting composition is from about 1 ppm to about 5,000 ppm, about 1 ppm to about 1,000 ppm, about 5 ppm to about 1,000 ppm, or about 5 ppm to about 500 ppm, based on the total volume of the system (i.e. the volume of the fluid treated according to the methods described herein).

In embodiments where the composition is added to the fluid system in a batch dosing in-line or offline. In embodiments, offline dosing provides a slug dosing suitable to coat the surfaces (e.g. containment) to provide barrier to the corrodents when the system is back in-line. The embodiments of batch dosing can be done when with or without fluid in the system. In embodiments, batch treatments can use up to 100% of the corrosion-inhibiting compositions applied between two spheres (e.g. pigs, as referred to in the industry). In embodiments, the batch treatments can be applied with a diluent (e.g. diesel, hydrocarbon, etc.) between about 20-80%, often about 50%, dependent upon operator preference.

In embodiments, the composition is added to the fluid system in a continuous dosing while the system is online.

In embodiments the composition is added at a flow rate of a flow line in which the composition is used that can be between 0 and 100 feet per second, or between 0.1 and 50 feet per second. The compositions can be formulated with water in order to facilitate addition to the flow line.

In embodiments where the composition is added to the fluid system in either a batch or continuous dosing application, the corrosion-inhibiting compositions provide improved corrosion inhibition in a system or on the treated surface in comparison to the same corrosion-inhibiting composition without the calcium-based nanoparticle as measured by reduced milli-inches per year (mpy). In embodiments the corrosion-inhibiting compositions reduce mpy to less than about 100 mpy, or less than about 50 mpy.

### EMBODIMENTS

The present disclosure is further defined by the following numbered embodiments:
1. A corrosion-inhibiting composition comprising: a calcium-based nanoparticle with an average particle size from about 1 nm to about 1000 nm; at least one corrosion inhibitor selected from the group consisting of quaternary ammonium compounds, imidazolines, phosphate esters, aromatic amines, fatty acid (or salts) amine condensates, organic sulfur compound and/or organic sulfonic acid amine, and combinations thereof; and solvent.
2. The composition of embodiment 1, wherein the calcium-based nanoparticle comprises a calcium hydroxide-based, calcium oxyhydroxide-based or calcium oxide-based nanoparticle.
3. The composition of any one of embodiments 1-2, wherein the calcium-based nanoparticle comprises a metal-based hydroxide or oxyhydroxide and/or a silicone-based oxide.
4. The composition of any one of embodiments 1-3, wherein the calcium-based nanoparticle has an average particle size from about 10-500 nm.
5. The composition of any one of embodiments 1-4, wherein the calcium-based nanoparticle comprises from about 0.01 wt-% to about 1 wt-% of the composition.
6. The composition of any one of embodiments 1-5, wherein the calcium-based nanoparticle is free of carbonate, sulfonate, phosphate and/or additional metals.
7. The composition of any one of embodiments 1-6, wherein the corrosion inhibitor(s) comprises from about 50 wt-% to about 99 wt-% of the composition.
8. The composition of any one of embodiments 1-7, wherein the solvent comprises from about 30 wt-% to about 90 wt-% of the composition.
9. The composition of any one of embodiments 1-8, further comprising at least about 0.1 wt-% to about 40 wt-% of at least one additional component selected from the group consisting of additional corrosion inhibitors, surfactants, polymers, pH modifiers, asphaltene inhibitors, paraffin inhibitors, scale inhibitors, metal complexing agents (chelants), emulsifiers, water clarifiers, dispersants, emulsion breakers and combinations thereof.
10. The composition of any one of embodiments 1-9, wherein the calcium oxide-based nanoparticle comprises from about 0.1 wt-% to about 1 wt-% of the composition, the corrosion inhibitor(s) comprises from about 50 wt-% to about 80 wt-% of the composition, and the solvent comprises from about 30 wt-% to about 80 wt-% of the composition.
11. Use of the corrosion-inhibiting composition of any one of embodiments 1-10 to inhibit corrosion on a surface in an oil—and—gas system.
12. A method of inhibiting corrosion at a surface, the method comprising: contacting the surface with a corrosive inhibiting effective amount of the corrosion-inhibiting composition according to any one of embodiments 1-10; and inhibiting corrosion of the surface, wherein the surface comprises metal and is in an oil—and—gas system, and wherein the contacting is added in a batch or continuous application.
13. The method of embodiment 12, wherein the composition is added to the system manually or automatically.
14. The method of any one of embodiments 12-13, wherein the corrosive inhibiting effective amount of the composition is from about 1 ppm to about 1,000 ppm, based on the total volume of the system.
15. The method of any one of embodiments 12-14, wherein the metal surface comprises steel.
16. The method of embodiment 15, wherein the surface is a containment used in the production, transportation, storage and/or separation of crude oil, natural gas or a biofuel process.
17. The method of any one of embodiments 12-16, wherein the system comprises a hydrocarbon fluid or gas, produced water, or combination thereof.
18. The method of any one of embodiments 12-17, wherein the corrosion-inhibiting composition is provided in a continuous dosing application.
19. The method of any one of embodiments 12-18, wherein the corrosion-inhibiting composition provides reduced corrosion measured by milli-inches per year less than about 50.
20. A treated metal containment comprising: a metal containment comprising a metal surface; and a barrier or film substantially coating the metal surface with a corrosive inhibiting effective amount of the corrosion-inhibiting composition according to any one of embodiments 1-10.
21. The treated metal containment of embodiment 20, wherein the corrosive inhibiting effective amount of the composition is from about 1 ppm to about 5,000 ppm, based on the total volume of the system.
22. The treated metal containment of any one of embodiments 20-21, wherein the metal surface comprises steel.
23. The treated metal containment of any one of embodiments 20-22, wherein the surface is a containment used in the production, transportation, storage and/or separation of crude oil, natural gas or a biofuel process.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Examples were conducted to identify compositions for improved corrosion inhibition performance using continuous corrosion inhibition treatment compositions. A blend of corrosion inhibitors described in Table 1 was utilized in the Example to combine with calcium-based nanoparticles including: AlOOH-Ca (150 ppm calcium), SiO₂—Ca, low calcium (2,000 ppm calcium), and SiO₂—Ca, high calcium (5,000 ppm calcium), made in the laboratory by combining nanosilica with calcium chloride in water.

TABLE 1

| | Blend 1 | | | |
|---|---|---|---|---|
| | | Activity of | | Activity in |
| | | Intermediate/ | | Final |
| | | Raw Material | Actual | CI Blend |
| | | Active | Activity in | (using 70% |
| Component | Wt-% | (%) | Blend 1 | Blend 1) |
| Quaternary ammonium | 56 | 92 | 52 | 36 |
| compounds | | | | |
| Fatty acid amine | 35 | 80 | 28 | 19 |
| condensate | | | | |
| Organic Sulfur | 9 | 100 | 9 | 6 |
| compound | | | | |
| Total Activity | 0 | 0 | 88 | 62 |

A concentrate Blend 1 shown in Table 1 was made by mixing quaternary ammonium compounds, a fatty acid amine condensate and an organic sulfur compound which, taking into account of their associated solvents in their base materials, had an overall activity of about 88%. An aliquot of Blend 1 was taken to which water was added making a CI Blend resulting in approximately 70% Blend I and 30% water, which resulted in an activity of the abovementioned components of about 62%. This was repeated multiple times using about 70% Blend 1 but replacing a small portion of the water with varying amounts of the various calcium-based nanoparticles.

The bubble test is designed to evaluate basic corrosion inhibition effectiveness and/or the partitioning properties of corrosion inhibitors. The corrosion inhibitor effectiveness is measured by how quickly and to what extent the inhibitor will enter the water phase from the oil phase under stagnant conditions. This test simulates, with respect to field conditions, low profile areas, such as, dead legs and water traps where no or very limited mixing exists and the performance of an inhibitor is determined by its capability to partition into the water phase. The bubble cell test is primarily used as a comparative test between multiple chemistries at various concentrations.

The tests were carried out using 1 liter glass vessels containing stratified layers of brine and oil. The vessels are continually sparged in the water phase with CO₂. The solution is stirred at 100 rpm to maintain a consistent mixing of the water phase. Care is taken to avoid mixing between the oil and water phase. The inhibitor is dosed directly into the oil phase and the partitioning effect is observed by monitoring the change in corrosion rate with time as measured using LPR through a three-electrode probe positioned in the water phase.

Bubble test studies evaluating the corrosion inhibiting ability of the CI Blends with calcium-based nanoparticles were conducted on a carbon steel electrode (Cl 018 grade). The corrosion rate was assessed electrochemically using linear polarization resistance (LPR) methodology based on the ASTM G-170, with the method conditions and testing parameters as shown in Table 2.

TABLE 2

| Parameters | Values |
|---|---|
| Temperature | 80° C. |
| Fluids | CO₂ saturated fluid with 3% NaCl brine |
| | (80%) with LVT-200 hydrocarbon (20%) |
| Gas | Continuous purge with CO₂ |
| Pressure | Atmospheric |
| pH | Approximately 3.7 |
| Duration | 3-4 hours pre-corrosion time (no CI added); |
| | 15 hours corrosion measurement |
| Dosage | CI was injected at 5 ppm based on |
| | the water phase |
| Data | Linear Polarized Resistance |

A low concentration was purposefully used in order to differentiate between the chemistries. The inhibited corrosion rate at about 15 hours after CI Blend injection was noted and a percentage inhibition determined by comparing with the corrosion rate of a carbon steel electrode under otherwise the same conditions in the absence of chemical corrosion inhibitor after the same time of exposure to the corrosive environment.

The methods include use of metal coupons (electrodes) affixed to a probe and electrically connected to a working and counter electrode through a potentiostat. The electrodes were immersed into the test fluid to measure corrosion rates and were calculated as per standard practice and outlined in standards ASTM G-3, ASTM G-59 and ASTM G-102. Linear polarized resistance tests are used as an effective screening method for assessing the corrosion inhibiting ability of additives or a composition to a corrosive solution.

Control Chemistries: The inhibited corrosion rate at about 15 hours after treatment with the test composition along with that at 15 hours after each of the three fluid exchanges and a percentage inhibition determined by comparing with the corrosion rate of a carbon steel electrode under otherwise the same conditions in the absence of chemical treatment after a similar time of exposure to the corrosive environment.

The results are summarized in Table 3.

TABLE 3

| | | | | | | Ratio of | | |
|---|---|---|---|---|---|---|---|---|
| | | | | Corrosion | | Corrosion | | |
| | | Corrosion | CI Blend | Inhibitor | Ca-Based | Inhibitor | Corrosion | |
| | | Inhibitor | Dose Rate | Active Dose | NP Dose | Active | Rate after | |
| | Ca-Based | Active | (Based on | (Based on | (Based on | Chemistry:Ca- | 15 hours of | |
| | NP in CI | Chemistry | Water Phase) | Water Phase) | Water Phase) | Based NP | CI Injection | % |
| Composition | Blend (%) | Activity (%) | (ppm) | (ppm) | (ppm) | in CI Blend | (mpy) | Protection |
| Blank | N/A | N/A | N/A | N/A | N/A | N/A | 441 | N/A |
| 70 CI Blend/ | 0 | 62 | 5 | 3 | 0.00 | N/A | 71 | 84 |
| 30 water | | | | | | | | |
| (Positive | | | | | | | | |
| Control) | | | | | | | | |
| Positive | 0.38 | 62 | 5 | 3 | 0.02 | 162 | 21 | 95 |
| Control + | | | | | | | | |
| AlOOH—Ca | | | | | | | | |
| (150 ppm | | | | | | | | |
| calcium) | | | | | | | | |
| Positive | 0.38 | 62 | 5 | 3 | 0.02 | 162 | 47 | 89 |
| Control + | | | | | | | | |
| SiO₂—Ca | | | | | | | | |
| (2,000 ppm | | | | | | | | |
| calcium) | | | | | | | | |
| Positive | 0.19 | 62 | 5 | 3 | 0.01 | 325 | 41 | 91 |
| Control + | | | | | | | | |
| SiO₂—Ca | | | | | | | | |
| (5,000 ppm | | | | | | | | |
| calcium) | | | | | | | | |

The calcium-based nanoparticles were blended to achieve about 0.2-0.4% in the final blends and taken for assessment in corrosion tests using carbon steel in the presence of salt water, hydrocarbon and carbon dioxide. Each of the final CI Blends were assessed at the same overall dose rate of approximately 5 ppm based on the water phase in corrosion tests under otherwise the same conditions. The data point used for determining the % inhibition in each test was at about 15 h after the chemical was injected which, taking into account the 3 h pre-corrosion time was about 18 h into the test. All CI Blends containing the calcium-based nanoparticles demonstrated improved performance compared with the CI blend without them.

Enhanced CI performance was gained with CI Blends containing the calcium-based nanoparticles compared with the CI Blend without the additives present. Under the conditions assessed, the inhibited corrosion rate was found to be about 30-70% with the incorporation of about 0.2 to about 0.4% of various calcium-based nanoparticles compared with overwise the same CI chemistry backbone without the additive. The inhibited corrosion rate is calculated by [(corrosion rate of the blank test without chemical-corrosion rate of the test with the chemical)/corrosion rate of the blank test without chemical]×100.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A corrosion-inhibiting composition comprising:
a non-functionalized calcium-based nanoparticle with an average particle size from about 1 nm to about 1000 nm;
at least one corrosion inhibitor selected from the group consisting of quaternary ammonium compounds, imidazolines, phosphate esters, aromatic amines, fatty acid (or salts) amine condensates, organic sulfur compound and/or organic sulfonic acid amine, and combinations thereof;
at least one surfactant; and
water and at least one additional solvent.

2. The composition of claim 1, wherein the calcium-based nanoparticle comprises a calcium hydroxide-based, calcium oxyhydroxide-based or calcium oxide-based nanoparticle.

3. The composition of claim 1, wherein the calcium-based nanoparticle comprises a metal-based hydroxide or oxyhydroxide and/or a silicone-based oxide.

4. The composition of claim 1, wherein the calcium-based nanoparticle has an average particle size from about 10-500 nm.

5. The composition of claim 1, wherein the calcium-based nanoparticle comprises from about 0.01 wt-% to about 1 wt-% of the composition, wherein the corrosion inhibitor(s) comprises from about 50 wt-% to about 99 wt-% of the composition, wherein the surfactant comprises from about 0.5 wt-% to about 5 wt-% of the composition, and wherein the water and at least one additional solvent comprises from about 30 wt-% to about 90 wt-% of the composition.

6. The composition of claim 1, wherein the calcium-based nanoparticle is free of carbonate, sulfonate, phosphate and/or additional metals.

7. The composition of claim 1, further comprising at least about 0.1 wt-% to about 40 wt-% of at least one additional component selected from the group consisting of additional corrosion inhibitors, surfactants, polymers, pH modifiers, asphaltene inhibitors, paraffin inhibitors, scale inhibitors, metal complexing agents (chelants), emulsifiers, water clarifiers, dispersants, emulsion breakers and combinations thereof.

8. Use of the corrosion-inhibiting composition of claim 1 to inhibit corrosion on a surface in an oil—and—gas system.

9. A method of inhibiting corrosion at a surface, the method comprising:
contacting the surface with a corrosive inhibiting effective amount of the corrosion-inhibiting composition according to claim 1; and
inhibiting corrosion of the surface, wherein the surface comprises metal and is in an oil—and—gas system, and wherein the contacting is added in a batch or continuous application.

10. The method of claim 9, wherein the composition is added to the system manually or automatically.

11. The method of claim 9, wherein the corrosive inhibiting effective amount of the composition is from about 1 ppm to about 1,000 ppm, based on the total volume of the system.

12. The method of claim 9, wherein the metal surface comprises steel.

13. The method of claim 12, wherein the surface is a containment used in the production, transportation, storage and/or separation of crude oil, natural gas or a biofuel process.

14. The method of claim 9, wherein the system comprises a hydrocarbon fluid or gas, produced water, or combination thereof.

15. The method of claim 9, wherein the corrosion-inhibiting composition is provided in a continuous dosing application.

16. The method of claim 9, wherein the corrosion-inhibiting composition provides reduced corrosion measured by milli-inches per year less than about 50.

17. A treated metal containment comprising:
a metal containment comprising a metal surface; and
a barrier or film substantially coating the metal surface with a corrosive inhibiting effective amount of the corrosion-inhibiting composition according to claim 1.

18. The treated metal containment of claim 17, wherein the corrosive inhibiting effective amount of the composition is from about 1 ppm to about 5,000 ppm, based on the total volume of the system.

19. The treated metal containment of claim 17, wherein the metal surface comprises steel.

20. The treated metal containment of claim 17, wherein the surface is a containment used in the production, transportation, storage and/or separation of crude oil, natural gas or a biofuel process.
